(19) United States
(12) Patent Application Publication
(10) Pub. No.: US 2007/0239962 A1
(43) Pub. Date: Oct. 11, 2007

(54) Pornograph Intercept Method

(76) Inventor: Dong Hee Lee, Daejeon (KR)

Correspondence Address: STAAS & HALSEY LLP, SUITE 700, 1201 NEW YORK AVENUE, N.W., WASHINGTON, DC, 20005, US

(21) Appl. No.: 11/630,894

(22) PCT Filed: Oct. 5, 2005
(86) PCT No.: PCT/KR05/03279

§ 371 Date: Dec. 27, 2006

(30) Foreign Application Priority Data
Nov. 5, 2004 (KR) 10-2004-0089668

(51) Int. Cl. G06F 12/00

(52) U.S. Cl. 711/216

(57) ABSTRACT

Provided is a pornograph intercepting method using a hash value, which extracts pornograph hash values from the entire or a part of pornograph files that have been spread on the Internet using a predetermined one-way hash function to construct a pornograph hash value database (DB), extracts a hash value (extracted hash value) from the entire or a part of a file to be transmitted, edited and executed in a computer using the one-way hash function, compares the pornograph hash values with the extracted hash value, and stops transmission or execution of the file or deletes the file when the file corresponds to a pornograph file, to thereby provide healthy Internet environment to adolescents using computers and block circulation of pornographic motion pictures that occupy the most of Internet traffic to utilize Internet infrastructure that is a national resource more productively.

### TECHNICAL FIELD

The present invention relates to a pornograph intercepting method, and more particularly, to a pornograph intercepting method using a hash value, which extracts pornograph hash values from the entire or a part of pornograph files that have been spread on the Internet using a predetermined one-way hash function to construct a pornograph hash value database (DB), extracts a hash value (extracted hash value) from the entire or a part of a file to be transmitted, edited and executed in a computer using the one-way hash function, compares the pornograph hash values with the extracted hash value, and stops transmission or execution of the file or deletes the file when the file corresponds to a pornograph file, to thereby prevent adolescents using computers from accessing illegal pornographic motion pictures to provide healthy Internet environment and block circulation of pornographic motion pictures that occupy the most of Internet traffic to utilize Internet infrastructure that is a national resource more productively.

### BACKGROUND ART

According to National Police Agency Cyber Terror Response Center's publication materials “Results of crackdown of pornograph distribution offenses and site operators through file sharing service (Electronic Times on 23rd of Jun. 2004)”, it was investigated that more than 90% of pornograph materials were distributed through file sharing such as P2P. According to research data of Korea Telecommunication (KT) on May, 2004 (Newsweek Korean edition on 24th of Aug. 2004), 88.76% of Internet data traffic is distributed through an interpersonal file sharing program P2P and a messenger program.

Korean Patent Laid-Open Publication No. 2004-46537 (Application No. 10-2002-74484, Cited Reference invention 1) discloses a pornograph intercepting method that intercepts specific colors (yellow, black, white, etc.,) when the colors exceed a predetermined threshold on a screen in VOD service. Korean Patent Laid-Open Publication No. 2002-27987 (Application No. 10-2000-58828, Cited Reference invention 2) discloses a pornograph intercepting method that constructs a DB of URLs of pornograph sites and blocks the sites when user computers attempt to access the pornograph sites.

Korean Patent Laid-Open Publication No. 2001-107528 (Application No. 10-2001-4025, Cited Reference invention 3) discloses a pornograph intercepting method that calculates/measures similarity of characteristic descriptors such as colors, textures and forms of pornographs and characteristic descriptors extracted from multimedia data received from the Internet and judges a pornograph grade of the multimedia data to intercept the multimedia data when the data corresponds to a pornograph.

However, the Cited Reference inventions 1 and 3 require a long period of time to analyze the colors of scenes because the colors of all the scenes should be analyzed. Furthermore, when multimedia data is judged to be a pornograph, reproduction of the pornograph is not prevented but only corresponding colors exceeding the threshold are intercepted. Thus, substantial and effective interception is not carried out and, even when multimedia data is not a pornograph, set colors can be intercepted.

While the Cited Reference invention 2 blocks the URLs of pornograph sites, it is not effective because files have been recently transmitted by a P2P system. Moreover, it cannot cope with pornographs copied to CDs and distributed.

### DISCLOSURE OF INVENTION

Technical Problem

Accordingly, the present invention has been made in view of the above problems occurring in the prior art, and it is an object of the present invention to provide a pornograph intercepting method using a hash value, which extracts hash values (pornograph hash values) from pornograph files previously distributed on the Internet to construct a pornograph hash value DB, extracts a hash value (extracted hash value) of a file to be transmitted, edited and reproduced (executed) in a computer, and compares the pornograph hash values with the extracted hash value to stop transmission or execution of a pornograph file or delete the corresponding file, to thereby provide healthy Internet environment to adolescents using computers and block distribution of pornographic motion pictures occupying the most of Internet traffic to utilize Internet infrastructure that is a national resources more productively.

Technical Solution

To accomplish the above object, according to an aspect of the present invention, there is a pornograph intercepting method using a hash value comprising: a DB construction step of extracting hash values (pornograph hash values) from the entire or a part of various pornographs using a predetermined one-way hash function and constructing a pornograph hash value DB; an extraction step of extracting a hash value (extracted hash value) of a part of a file using the hash function when the file, which is stored in a computer, is reproduced, transmitted or received through a network; a comparison step of comparing the extracted hash value with the pornograph hash values of the pornograph hash value DB; and a suspending step of suspending reproduction (execution), edition or transmission of the file when there is a pornograph hash value identical to the extracted hash value.

The pornograph intercepting method further comprises a step of classifying the pornograph hash values by grades according to grades of the pornographs, and a step of setting a grade of pornograph to be intercepted after the DB construction step. Preferably, the comparison step compares the extracted hash value with pornograph hash values having grades higher than the predetermined grade set in the grade setting step.

In the DB construction step, the pornograph hash values can be transmitted from a server through a network.

The DB constructed in the DB construction step is located in a server. The pornograph intercepting method further includes a step of transmitting the extracted hash value to the server after the extraction step. The comparison step is executed in the server, and a comparison result can be received from the server after the comparison step. The suspending step is performed after the comparison result is received.

### BRIEF DESCRIPTION OF THE DRAWINGS

Further objects and advantages of the invention can be more fully understood from the following detailed description taken in conjunction with the accompanying drawings, in which:

FIG. 1 is a flow chart showing a process of intercepting pornographs when a file is reproduced according to an embodiment of the present invention;

FIG. 2 is a flow chart showing a process of intercepting pornographs when a file is transmitted according to another embodiment of the present invention; and

FIG. 3 is a flow chart showing a method of transmitting a hash value of a transmitted file to a server and processing the hash value in the interception of pornographs when a file is transmitted according to another embodiment of the present invention.

### EXPLANATION OF SYMBOLS IN THE FIGURES

100. program installation step 110. DB construction step

120. extraction step 130. comparison step

140. blocking step 142. file reproduction step

144. file transmission step 150. transmission step

### BEST MODE FOR CARRYING OUT THE INVENTION

The present invention will now be described in detail in connection with preferred embodiments with reference to the accompanying drawings. For reference, like reference characters designate corresponding parts throughout several views.

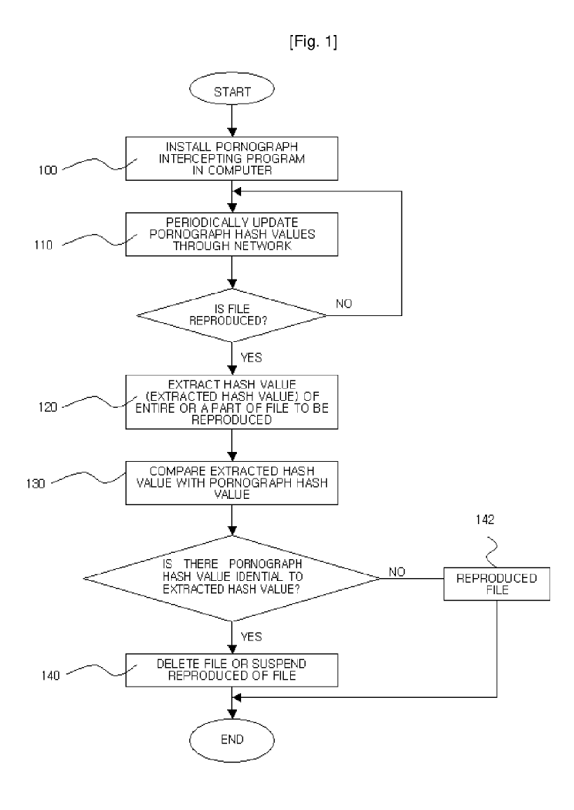

FIG. 1 is a flow chart showing a process of intercepting pornographs when a file is reproduced according to an embodiment of the present invention. Referring to FIG. 1, when a user attempts to intercept pornographs, a pornograph intercepting program is installed in a computer (program installation step 100). The program is acquired such that pornograph hash values are downloaded from a server having the pornograph hash values through a network automatically periodically or manually when required, to construct a database (DB) of the pornograph hash values (DB construction step 110). The pornograph hash values are hash values extracted according to a specific one-way hash function. While the pornograph hash values are hash values with respect to the entire or a part of corresponding pornograph, it is preferable that they concern the part of the pornograph in consideration of easiness of construction of the pornograph hash value DB.

When a computer reproduces (executes) or edits a specific file, transmits the file to another computer, or receives a file from another computer, the program extracts a hash value of part of the file executed, transmitted or edited (extraction step 120). When the file is transmitted, the program can extract a hash value with respect to the entire file. It is preferable that the hash value with respect to part of the file is extracted when the file is received. While the entire file is received and then the hash value of the file is extracted when the file is received, it is preferable that the hash value is extracted in the middle of receiving the file to judge whether the file corresponds to a pornograph.

The hash value (extracted hash value) extracted in the extraction step (120) is compared to the pornograph hash values in the DB (comparison step 130). When the extracted hash value is identical to a pornograph hash value stored in the DB, transmission, reproduction or edition of the corresponding file is blocked (blocking step 140). The file blocked in the blocking step (140) can be automatically deleted if required.

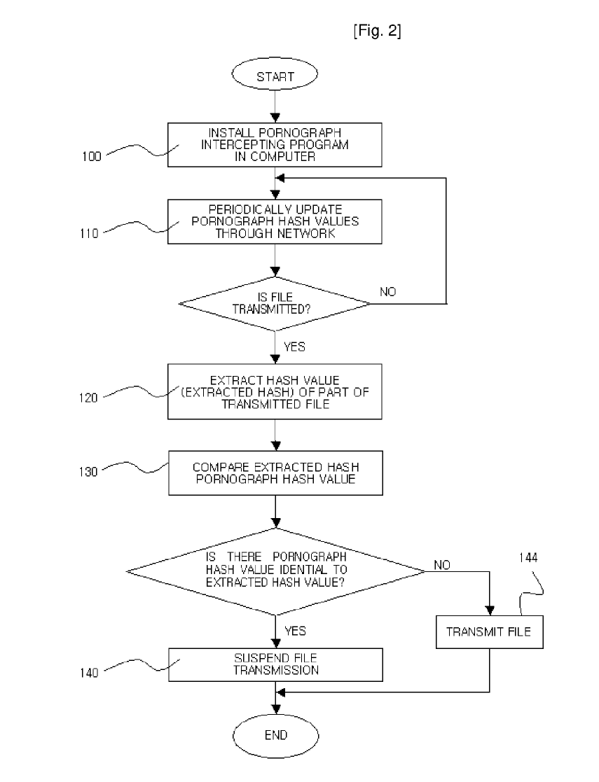

FIG. 2 is a flow chart showing a process of intercepting pornographs when a file is transmitted according to another embodiment of the present invention. Referring to FIG. 2, the hash value of the file reproduced in the computer is not extracted but the hash value of part of the file transmitted or received is extracted in the extraction step (120). The file is transmitted when the file is not a pornograph (file transmission step 144). When the file corresponds to a pornograph, the transmission of the file is stopped or the file is deleted (blocking step 140), which is different from the corresponding step of FIG. 1. Here, when the file is transmitted, the program can extract a hash value with respect to the entire file. When the file is received, it is preferable that the hash value of part of the file is extracted. While the hash value can be extracted after the entire file is received when the file is received, it is preferable that the hash value is extracted in the middle of receiving the file to judge whether the file is a pornograph or not.

FIG. 2 shows the pornograph intercepting method that judges whether a file corresponds to a pornograph or not when the file is transmitted in a computer and intercepts the file when the file corresponds to a pornograph.

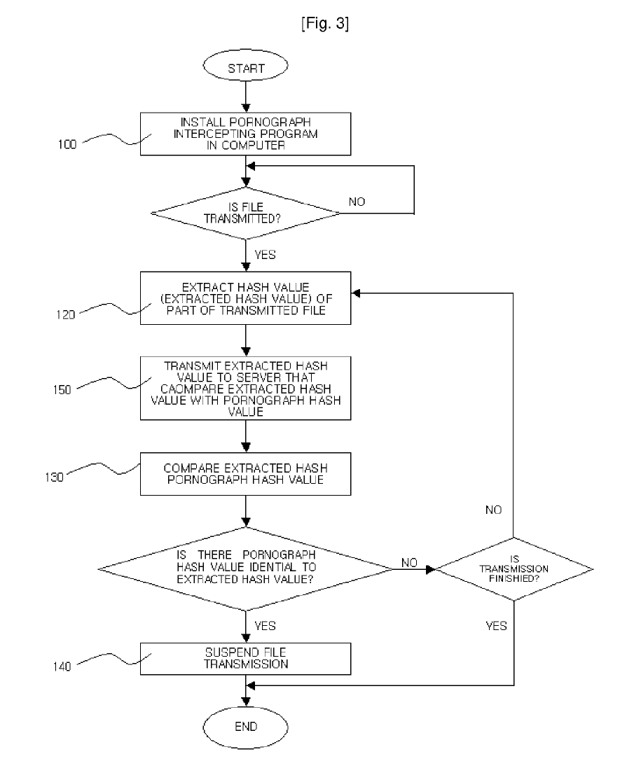

FIG. 3 is a flow chart showing a method of transmitting a hash value of a transmitted file to a server and processing the hash value in the interception of pornographs when a file is transmitted according to another embodiment of the present invention. The process shown in FIG. 3 is similar to the process of FIG. 1 except that it additionally includes a transmission step (150) of transmitting the hash value (extracted hash value) extracted in the extraction step (120) to a server that compares the extracted hash value to pornograph hash values and the server executes the comparison step (130) comparing the extracted hash value to the pornograph hash values. In the case of the process of FIG. 3, the pornograph hash values exist in the server and the step of downloading the pornograph hash values to the computer is not carried out.

While it is not illustrated in detail in FIGS. 1, 2 and 3, the pornograph intercepting program is deleted only when a predetermined password is input when the pornograph intercepting program is required to be deleted. Furthermore, a function of searching for a file stored in the computer, deleting the file when the file is judged to be a pornograph, setting grades of pornograph hash values, constructing a DB of the pornograph hash values, and setting only pornographs having grades higher than a predetermined grade as the object of interception can be added.

### INDUSTRIAL APPLICABILITY

As described above, the present invention prevents adolescents using computers from accessing illegal pornographic motion pictures to provide healthy Internet environment. Moreover, the present invention blocks distribution of pornographic motion pictures that occupy the most of Internet traffic to utilize the Internet infrastructure that is a national resource more productively.

Furthermore, the present invention overcomes the limit of conventional pornograph intercepting methods including a method of blocking URLs and a method of blocking keywords and is able to intercept pornographs distributed interpersonally. In addition, the present invention can prevent reproduction of pornograph even when the pornograph is acquired off-line.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A pornograph intercepting method using a hash value comprising:
a DB construction step of extracting hash values (pornograph hash values) from the entire or a part of various pornographs using a predetermined one-way hash function and constructing a pornograph hash value DB;
an extracting step of extracting a hash value (extracted has value) of a part of a file using the hash function when the file, which is stored in a computer, is reproduced, transmitted or received through a network;
a comparison step of comparing the extracted hash value with the pornograph hash values of the pornograph hash values DB; and
a blocking step of suspending reproduction (execution), edition or transmission of the file when there is a pornograph hash values identical to the extracted hash value.

2. The pornograph intercepting method as claimed in claim 1,
further comprising a classifying step of classifying the pornograph hash values by grades according to grades of the pornographs; and
a grade setting step of setting a grade of pornograph to be intercepted after the DB construction step,
wherein the comparison step compares the extracted hash value with pornograph hash values having grades higher than predetermined grade set in the grade setting step.

3. The pornograph intercepting method as claimed in claim 1,
wherein the pornograph hash values are transmitted from a server through a network in the DB construction step.

4. The pornograph intercepting method as claimed in claim 2,
wherein the pornograph hash values are transmitted from a server through a network in the DB construction step.
